(19) United States
(12) Patent Application Publication
(10) Pub. No.: US 2026/0290212 A1
(43) Pub. Date: Sep. 24, 2026

(54) DISPLAY APPARATUS MANAGEMENT METHOD, DISPLAY SYSTEM, AND INFORMATION PROCESSING APPARATUS

(71) Applicant: SEIKO EPSON CORPORATION, Tokyo (JP)

(72) Inventors: Koichiro OTA, Omachi-shi (JP); Toshiki FUJIMORI, Chino-shi (JP)

(73) Assignee: SEIKO EPSON CORPORATION, Tokyo (JP)

(21) Appl. No.: 19/569,452

(22) Filed: Mar. 17, 2026

(30) Foreign Application Priority Data
Mar. 18, 2025 (JP) 2025-043692

(51) Int. Cl. G09G 3/00

(52) U.S. Cl. CPC G09G 3/001; G09G 2320/0606; G09G 2320/0626; G09G 2320/08; G09G 2360/04; G09G 2360/145; G09G 2360/16; G09G 2370/042

(57) ABSTRACT

A display apparatus management method includes storing, with a first information processing apparatus, at least one of first identification information and second identification information and use form information, transmitting, with the first information processing apparatus, the use form information to a first display apparatus via a communication network, and projecting, with the first display apparatus, a projection image based on the use form information.

The present application is based on, and claims priority from JP Application Serial Number 2025-043692, filed Mar. 18, 2025, the disclosure of which is hereby incorporated by reference herein in its entirety.

### BACKGROUND

### 1. Technical Field

The present disclosure relates to a display apparatus management method, a display system, and an information processing apparatus.

### 2. Related Art

A service for lending display apparatuses having various kinds of performance to a user according to a contract with the user is publicly-known. JP-A-2024-66761 describes a rental service for home appliances in general.

JP-A-2024-66761 is an example of the related art.

In the rental service disclosed in JP-A-2024-66761, there is a problem in that a service desired by a user under a contract and a service actually provided sometimes do not match.

For example, in the rental service, a display apparatus having performance desired by the user is sometimes out of stock. In the related art, in that case, the user of the service has to rent a high-performance display apparatus that is not originally necessary instead of the desired device. In such a case, the service desired by the user and the service actually provided do not match. It is likely that the satisfaction of the user may decrease. For example, since lending of a higher performance display apparatus is more expensive, the satisfaction of the user decreases.

### SUMMARY

According to an aspect of the present disclosure, there is provided a display apparatus management method including: storing, with a first information processing apparatus, at least one of first identification information and second identification information and use form information; connecting, with the first information processing apparatus, to a first display apparatus via a communication network; transmitting, with the first information processing apparatus, the use form information to the first display apparatus based on at least one of the first identification information and the second identification information; and causing the first display apparatus to project a projection image based on the use form information, wherein the first identification information is identification information indicating the first display apparatus, the second identification information is identification information indicating a user of the first display apparatus, the use form information is correlated with the at least one of the first identification information and the second identification information, and the use form information is information for limiting at least a part of a use form of a function of the first display apparatus.

According to an aspect of the present disclosure, there is provided a display apparatus management method including: storing, with a first information processing apparatus, at least one of first identification information and second identification information; connecting, with the first information processing apparatus, to a first display apparatus and a second display apparatus via a communication network; storing, with the first information processing apparatus, a first threshold that is a threshold of luminance of the first display apparatus; and presenting the second display apparatus as a candidate replacement display apparatus for the first display apparatus when the first information processing apparatus receives second notification information concerning a state of the first display apparatus and when luminance of the second display apparatus exceeds the first threshold, wherein the first identification information is identification information indicating the first display apparatus, the second identification information is identification information indicating a user of the first display apparatus, and the first threshold is correlated with the at least one of the first identification information and the second identification information.

According to an aspect of the present disclosure, there is provided a display system including: a first information processing apparatus configured to store at least one of first identification information and second identification information and use form information, the first information processing apparatus being connected to a first display apparatus via a communication network, the first identification information being identification information indicating the first display apparatus, the second identification information being identification information indicating a user of the first display apparatus, the use form information being correlated with the at least one of the first identification information and the second identification information, the use form information being information for limiting at least a part of a use form of a function of the first display apparatus, the first information processing apparatus transmitting the use form information to the first display apparatus based on at least one of the first identification information and the second identification information; and the first display apparatus projecting a projection image based on the use form information.

According to an aspect of the present disclosure, there is provided an information processing apparatus, the information processing apparatus storing at least one of first identification information and second identification information, the information processing apparatus being connected to a first display apparatus and a second display apparatus via a communication network, the information processing apparatus storing a first threshold that is a threshold of luminance of the first display apparatus, the first identification information being identification information indicating the first display apparatus, the second identification information being identification information indicating a user of the first display apparatus, the first threshold being correlated with the at least one of the first identification information and the second identification information, wherein, when the information processing apparatus receives second notification information concerning a state of the first display apparatus and when luminance of the second display apparatus exceeds the first threshold, the second display apparatus is presented as a candidate replacement display apparatus for the first display apparatus.

### BRIEF DESCRIPTION OF THE DRAWINGS

FIG. 1 is a configuration example including a display system according to a first embodiment of the present disclosure.

FIG. 2 is a configuration example of an information processing apparatus.

FIG. 3 is a configuration example of a storage device.

FIG. 4 is a configuration example of a display apparatus.

FIG. 5 is a configuration example of registration information.

FIG. 6 is a flowchart illustrating an example of a flow of processing of the display system.

FIG. 7 is a configuration example including the display system according to a modification 1.

FIG. 8 is a configuration example of first registration information included in registration information according to the modification 1.

FIG. 9 is a configuration example of second registration information included in the registration information according to the modification 1.

FIG. 10 is a flowchart illustrating an example of a flow of processing of the display system according to the modification 1.

FIG. 11 is a first portion of a flowchart illustrating an example of a flow of processing of the display system according to a modification 2.

FIG. 12 is a second portion of the flowchart illustrating the example of the flow of the processing of the display system according to the modification 2.

FIG. 13 is a configuration example including the display system according to a modification 3.

FIG. 14 is a flowchart illustrating an example of a flow of processing of the display system according to the modification 3.

FIG. 15 is a flowchart illustrating an example of a flow of processing of the display system according to a modification 4.

FIG. 16 is a flowchart illustrating an example of a flow of processing of the display system according to a modification 5.

FIG. 17 is a flowchart illustrating an example of a flow of processing of the display apparatus according to a modification 6.

FIG. 18 is a configuration example of a setting screen according to the modification 6.

FIG. 19 is a configuration example of a change rejection screen according to the modification 6.

FIG. 20 is a flowchart illustrating an example of a flow of processing of the display apparatus according to a modification 7.

FIG. 21 is a configuration example of a setting screen according to the modification 7.

FIG. 22 is a configuration example of another setting screen according to the modification 7.

### DESCRIPTION OF EMBODIMENTS

Hereinafter, embodiments of the present disclosure are explained with reference to the accompanying drawings.

### First Embodiment

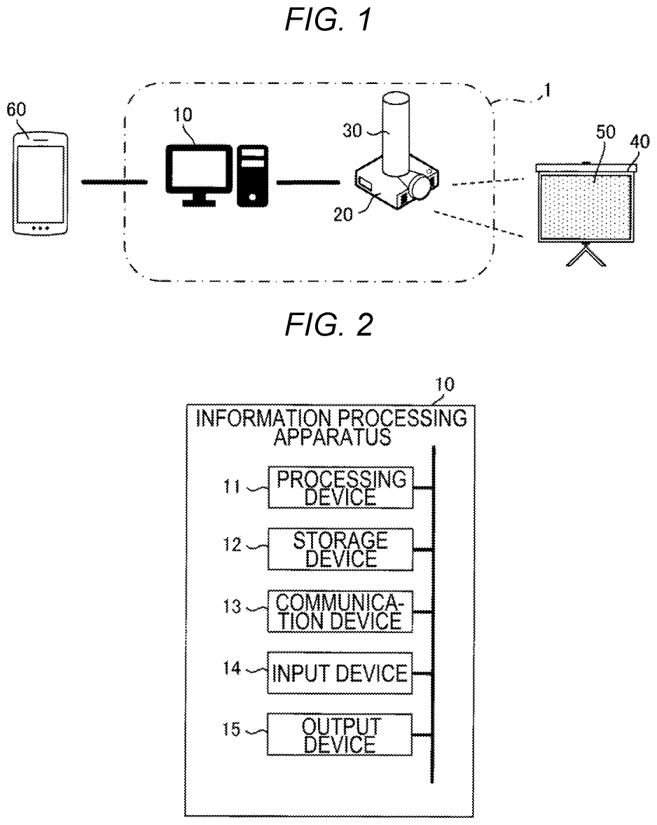

A configuration example including a display system 1 according to a first embodiment of the present disclosure is illustrated in FIG. 1. The display system 1 includes an information processing apparatus 10 and a display apparatus 20. The information processing apparatus 10 and the display apparatus 20 are connected via a communication network. The communication network may include a wired communication network. The communication network may include a wireless communication network.

The display apparatus 20 is, for example, a projector. The display apparatus 20 includes a light source. The display apparatus 20 projects a projection image 50 onto a projection area 40 using light from the light source. The projection area 40 is, for example, a projection screen. The projection area 40 is not limited to the projection screen. The projection image 50 may include a still image. The projection image 50 may include a moving image. The display apparatus 20 may output sound in addition to projecting the projection image 50.

The display apparatus 20 may be a display apparatus other than the projector. Instead of or in addition to projecting the projection image 50, the display apparatus 20 may display an image not by projection. For example, the display apparatus 20 may be a display apparatus including a liquid crystal display device or an LED display device.

The display apparatus 20 may be a lending target. For example, an owner of the display apparatus 20 may be a company that operates a lending business. A user of the display apparatus 20 may be a customer, that is, an end user who rents the display apparatus 20 from the owner of the display apparatus 20. Hereinafter, “owner” simply referred to in the present specification sometimes means the owner of the display apparatus 20. Similarly, “user” simply referred to in the present specification sometimes means the user of the display apparatus 20.

The display apparatus 20 is attached using a fixture 30. The fixture 30 is equipment for installing the display apparatus 20 in a use space.

A terminal 60 may be provided as an interface terminal for accessing at least one of the information processing apparatus 10 and the display apparatus 20. The terminal 60 is operated by, for example, the owner of the display apparatus 20. The terminal 60 is, for example, a mobile terminal. A specific example of the terminal 60 is a smartphone or a tablet terminal.

The information processing apparatus 10 is, for example, a first information processing apparatus. The display apparatus 20 is, for example, a first display apparatus. The display system 1 executes a display apparatus management method as a method described in the present specification.

FIG. 2 illustrates a configuration example of the information processing apparatus 10. The information processing apparatus 10 has a hardware configuration serving as a publicly-known computer. The information processing apparatus 10 includes, for example, a processing device 11 and a storage device 12. The processing device 11 includes, for example, a processor. The processor can be manufactured using an integrated circuit, an application specific integrated circuit (ASIC), a field programmable gate array (FPGA), or the like. The storage device 12 includes a storage medium. The storage medium includes, for example, a semiconductor memory device, a magnetic disk device, and the like. A part or the entire storage medium may be a non-transitory storage medium.

The information processing apparatus 10 includes a communication device 13. The communication device 13 is, for example, a network interface. The communication device 13 transmits and receives information by communicating with external devices via a communication network. The external devices are, for example, the display apparatus 20 and the terminal 60. The external devices may be other computers. The communication device 13 can perform at least one of wired communication and wireless communication.

The information processing apparatus 10 includes an input device 14 and an output device 15. The input device 14 includes, for example, a keyboard and a mouse. The output device 15 includes, for example, a liquid crystal display device and a printing device. The communication device 13 may function as a part of the input device 14. The communication device 13 may function as a part of the output device 15.

The hardware configuration of the information processing apparatus 10 is not limited to that illustrated in FIG. 2. The information processing apparatus 10 may be a computer having another configuration. For example, the information processing apparatus 10 may have a configuration serving as a publicly-known mobile terminal. The publicly-known mobile terminal is, for example, a mobile phone, a smartphone, or a tablet terminal.

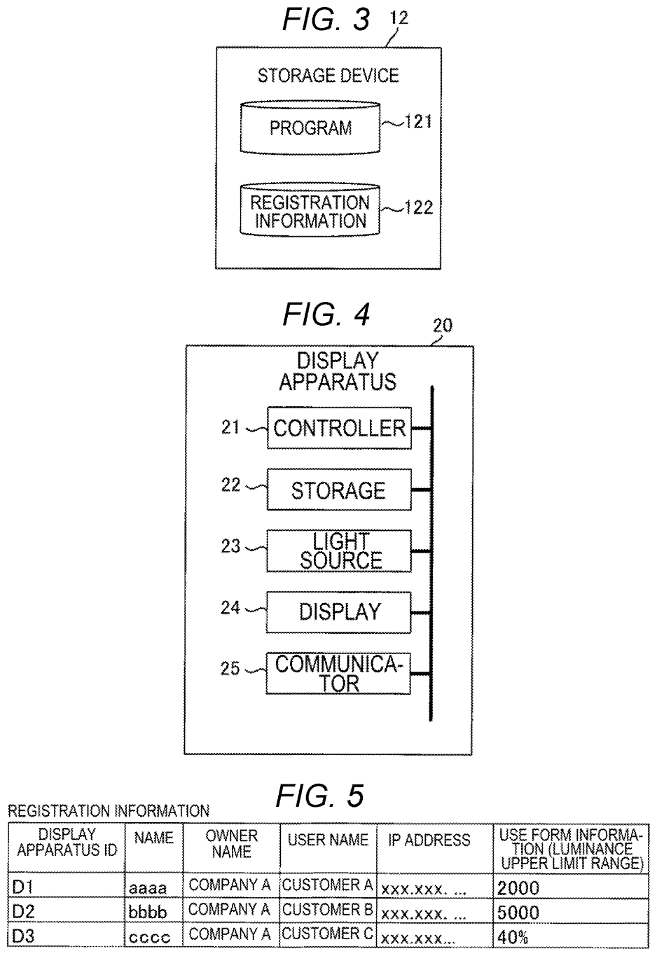

A configuration example of the storage device 12 is illustrated in FIG. 3. The storage device 12 stores, for example, a program 121 and registration information 122. The program 121 specifies an operation of the information processing apparatus 10. The information processing apparatus 10 executes the program 121 to thereby implement functions explained in the present embodiment. That is, the program 121 causes a computer to function as the information processing apparatus 10 according to the present embodiment.

FIG. 4 illustrates a configuration example of the display apparatus 20. The display apparatus 20 includes a controller 21, a storage 22, a light source 23, a display 24, and a communicator 25. The controller 21 controls an entire operation of the display apparatus 20. The controller 21 may include one or a plurality of processors or may include a dedicated processing device such as an application specific integrated circuit (ASIC) or a field programmable gate array (FPGA).

The storage 22 includes a random access memory (RAM) and a read only memory (ROM) and stores information. The storage 22 may store a not-illustrated program to be executed by the controller 21. The storage 22 may store information concerning setting of the display apparatus 20. The information concerning the setting of the display apparatus 20 includes, for example, a setting value concerning the light source 23.

The light source 23 emits light. The display 24 outputs the projection image 50 using the light emitted from the light source 23 to thereby display the projection image 50. The communicator 25 is, for example, a network interface. The communicator 25 transmits and receives information by communicating with an external device via a communication network. The external device is, for example, the information processing apparatus 10 or the terminal 60. The communicator 25 can perform at least one of wired communication and wireless communication.

Installation work for the display apparatus 20 is performed according to, for example, a publicly-known procedure. For example, the owner or the user of the display apparatus 20 installs the display apparatus 20 in a desired space. At this time, a not-illustrated power supply terminal of the display apparatus 20 is coupled to the power socket. Appropriate work is performed on the communicator 25. The work for the communicator 25 is, for example, work of connecting a cable of a local area network (LAN). Alternatively, the work for the communicator 25 is, for example, setting work concerning wireless LAN or near field communication.

An example of a configuration in which the display apparatus 20 is fixed using the fixture 30 is explained below. The fixture 30 includes, for example, an adapter and a coupling shaft for attaching the display apparatus 20 to a ceiling. The coupling shaft is fixed to the ceiling in advance. The adapter and the coupling shaft are fixed to each other in advance. A plurality of screw holes are provided in the display apparatus 20. In the adapter of the fixture 30, openings are provided at positions corresponding to the screw holes of the display apparatus 20. Screws are screwed in the screw holes of the display apparatus 20 through the openings of the adapter, whereby the display apparatus 20 is fastened and fixed to the adapter. Accordingly, the display apparatus 20 is fixed to the ceiling via the fixture 30.

The above is an example and a specific configuration of and a specific attachment method for the fixture 30 are not limited to the above. For example, the fixture 30 may fix the display apparatus 20 to a wall or a floor rather than the ceiling. The fixture 30 may not fix but may simply support the display apparatus 20.

A configuration of the terminal 60 is not particularly illustrated. The terminal 60 can have a configuration serving as a publicly-known mobile terminal. The publicly-known mobile terminal is, for example, a personal computer, a mobile phone, a smartphone, or a tablet terminal.

A configuration example of the registration information 122 is illustrated in FIG. 5. The registration information 122 includes information concerning at least one display apparatus. The registration information 122 correlates, for each display apparatus, information concerning the display apparatus with identification information indicating the display apparatus. The identification information indicating the display apparatus is, for example, a display apparatus ID. The identification information indicating the display apparatus 20 is first identification information.

The information concerning the display apparatus includes a name of the display apparatus, an owner name that is identification information indicating an owner of the display apparatus, a user name that is identification information indicating a user of the display apparatus, an IP address of the display apparatus, and use form information of the display apparatus. The name of the display apparatus is, for example, a model name of a projector. The owner name is, for example, a name of a company that operates a lending business. The user name is, for example, a name or an appellation of an end user who rents the display apparatus. The user name linked with the identification information indicating the display apparatus 20 is second identification information. The IP address is information for specifying the display apparatus, for example, on the Internet or a LAN.

An owner name and a user name coinciding for a certain display apparatus in the registration information 122 may indicate that the display apparatus is in stock at the owner. In that case, it can be said that the display apparatus can be optionally lent according to, for example, a contract with a new end user.

The use form information is information for limiting at least a part of a use form of a function of the display apparatus. The function is, for example, a function of projecting the projection image 50. Limiting the use form means, for example, limiting the function of the display apparatus. Limiting the function of the display apparatus means, for example, limiting the luminance of the projection image 50, limiting the resolution of the projection image 50, or limiting a brightness automatic correction function of the display apparatus. Limiting the function may include, for example, stopping the function or, when the function has performance represented by a numerical range, limiting a numerical range of operability at the time of use to be narrower than a numerical range defined by the specifications. The operation range is, for example, a range from a lower limit to an upper limit of the luminance or a range from a lower limit to an upper limit of the resolution.

A luminance upper limit range illustrated in FIG. 5 is an example of the use form information. The luminance upper limit range indicates an upper limit range of the luminance of a display apparatus being lent. The luminance upper limit range includes a threshold indicating a boundary of a range concerning the luminance upper limit. The luminance upper limit means an upper limit value of luminance achieved in a specific use form of the display apparatus. For example, the luminance upper limit represents luminance in the case in which white is displayed. The threshold indicating the boundary of the range concerning the luminance upper limit is, for example, a first threshold or a second threshold.

The threshold may be represented by a light flux output from a light source of the display apparatus. A unit of the light flux is, for example, a lumen. The threshold may be represented by a ratio to a rated output of the light source of the display apparatus.

In the example of FIG. 5, a luminance upper limit range of a display apparatus, a display apparatus ID of which is “D1”, is “2000”. As an example of an interpretation, this indicates an agreement that the luminance upper limit of the display apparatus must be 2000 lumens or more. In other words, it can be said that a minimum guarantee value of the luminance upper limit of the display apparatus is 2000 lumens. The luminance upper limit range is determined based on, for example, a contract between the owner and the user. For example, in the contract, the owner is obliged to set the luminance upper limit of the display apparatus to 2000 lumens or more. The threshold explained above is the first threshold.

As an example of another interpretation, the luminance upper limit range being “2000” indicates an agreement that the luminance upper limit of the display apparatus must not exceed 2000 lumens. For example, in the contract, the user is prohibited from setting the luminance upper limit of the display apparatus to a value exceeding 2000 lumens. In other words, it can be said that a maximum value of the luminance of the display apparatus that the user can use is 2000 lumens. The threshold explained above is the second threshold.

The use form information may include an individual value for each of these interpretations concerning the luminance upper limit range. For example, the luminance upper limit range may be defined such that the luminance upper limit of the display apparatus must be 2000 lumens or more and the luminance upper limit of the display apparatus must not exceed 3000 lumens.

Referring back to FIG. 5, a luminance upper limit range of a display apparatus, a display apparatus ID of which is “D2”, is 5000 lumens. A luminance upper limit range of a display apparatus, a display apparatus ID of which is “D3”, is defined not as a value of a light flux but as “40%” as a ratio. This represents a ratio to a specific reference value. For example, this means a value of 40% of the light flux corresponding to a rating of the display apparatus. As a specific example, when a luminance upper limit by the rating of the display apparatus is 5000 lumens, the luminance upper limit range is 5000×40/100=2000 [lumens].

The use form information may include other information instead of or in addition to the luminance upper limit range. For example, the use form information may include information for limiting driving of a pixel shift device provided in the display apparatus 20. Specifically, the information processing apparatus 10 transmits a request to stop driving the pixel shift device to the display apparatus 20 as the use form information. The display apparatus 20 that has received the use form information sets a mode of the display apparatus 20 as a mode for stopping the driving of the pixel shift device. The display apparatus 20 set to the mode for stopping the driving of the pixel shift device displays the projection image 50 in the projection area 40. Accordingly, it is possible to provide, to the user, the projection image 50, the resolution of which is limited.

In the present embodiment, the use form information is correlated with the display apparatus ID. That is, the use form information is defined for each display apparatus. As a modification, the use form information may be correlated with the user name. That is, the use form information may be defined for each user. In that case, the registration information 122 may not include the display apparatus ID. Further, the use form information may be correlated with both of the display apparatus ID and the user name. The use form information is information agreed upon between the owner and the user and does not always need to match a specification value of the display apparatus.

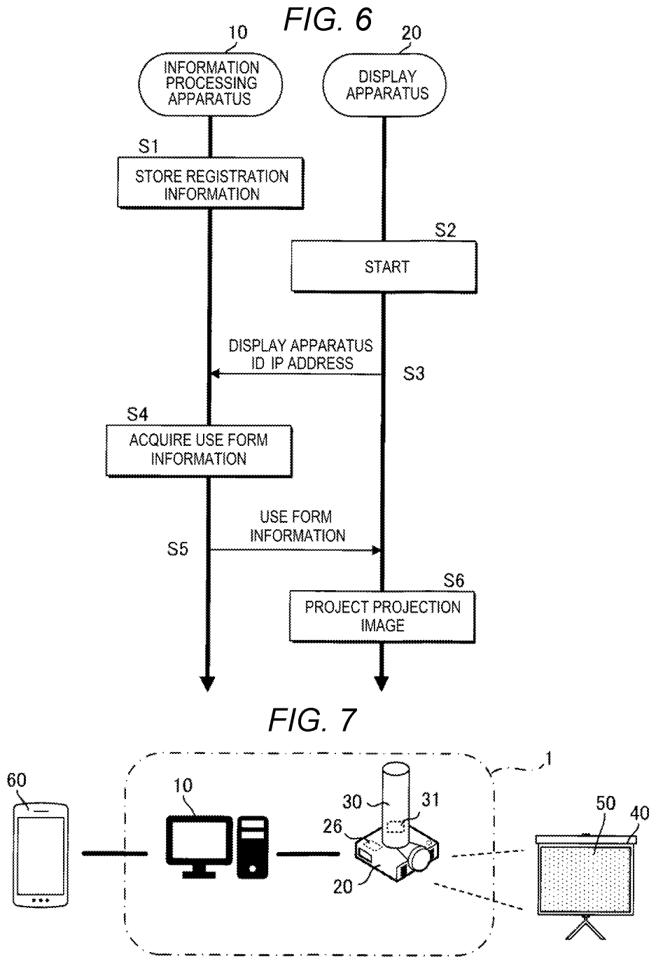

FIG. 6 is a flowchart illustrating an example of a flow of processing of the display system 1. This flowchart represents a display apparatus management method according to the present embodiment. In the processing illustrated in FIG. 6, first, in step S1, the information processing apparatus 10 stores the registration information 122 in the storage device 12. Step S1 is a first storage step.

A specific execution procedure of step S1 can be optionally designed based on a publicly-known technique or the like. A specific example is explained below. First, the owner of the display apparatus 20 logs in to the information processing apparatus 10 via the terminal 60. Subsequently, the owner inputs information concerning a plurality of display apparatuses 20 to the information processing apparatus 10 as the registration information 122 via the terminal 60. The information processing apparatus 10 stores the input information as the registration information 122.

In the storage 22 of each display apparatus 20, a display apparatus ID and an IP address of the display apparatus 20 are stored. A display apparatus ID and an IP address included in the registration information 122 coincide or are associated with the display apparatus ID and the IP address stored in the storage 22 of the display apparatus 20.

When the registration information 122 has already been stored, the owner can optionally update the registration information 122. For example, the terminal 60 may display the registration information 122 as a list. For example, in response to a certain display apparatus being lent to a certain end user, the owner may change a user name of the display apparatus from a name of the owner itself to a name of the end user via the terminal 60. In response to a certain display apparatus being returned from an end user to the owner, the owner may change a user name of the display apparatus from a name of the end user to the name of the owner itself via the terminal 60.

Subsequently, in step S2, the display apparatus 20 starts. Step S2 is executed, for example, according to power-on operation from the terminal 60. The owner may transmit a power-on instruction to the display apparatus 20 via the terminal 60 and the information processing apparatus 10 or directly to the display apparatus 20 via the terminal 60.

Subsequently, in step S3, the display apparatus 20 transmits the display apparatus ID and the IP address to the information processing apparatus 10. The information processing apparatus 10 receives the display apparatus ID and the IP address.

Subsequently, in step S4, the information processing apparatus 10 acquires use form information of the display apparatus 20. The use form information of the display apparatus 20 is acquired, for example, by searching through the registration information 122 based on the display apparatus ID received in step S3.

Subsequently, in step S5, the information processing apparatus 10 transmits the use form information acquired in step S4 to the display apparatus 20 based on identification information indicating the display apparatus 20 or the user name. Here, a transmission destination can be an IP address received in step S3. The display apparatus 20 receives the use form information.

Subsequently, in step S6, the display apparatus 20 projects the projection image 50 based on the use form information. For example, the controller 21 of the display apparatus 20 controls the light flux of the light source 23 based on the use form information. Accordingly, the display 24 projects the projection image 50.

Specific content of the control in step S6 can be optionally designed by the owner. For example, when the luminance upper limit range of the display apparatus 20 is stored in the information processing apparatus 10 as 2000 lumens, the controller 21 of the display apparatus 20 determines whether an upper limit value of luminance in the display apparatus 20 is 2000 lumens or more. A method of acquiring a luminance upper limit is optional. For example, a specification value stored in advance in the display apparatus 20 may be referred to as the upper limit value of the luminance. Alternatively, for example, a method described in a modification 3 explained below may be used.

When the upper limit value of the luminance in the display apparatus 20 is less than 2000 lumens according to, for example, deterioration over time of the light source 23, the controller 21 controls the light source 23 such that the upper limit of the luminance is 2000 lumens or more. As a specific example, the controller 21 may change a setting value concerning the luminance upper limit of the light source 23. Alternatively, the controller 21 may change electric power supplied to the light source 23 or output of the light source 23. In that case, the controller 21 may determine appropriate electric power or output based on a required luminance upper limit.

As explained above, with the display system 1 according to the first embodiment, when the upper limit value of the luminance in the display apparatus 20 decreases because of deterioration of the display apparatus 20 or an unintended setting change, the upper limit value of the luminance in the display apparatus 20 can be corrected to an appropriate value. Accordingly, it is possible to match a service desired by the user under a contract and a service actually provided by the display apparatus 20.

When the upper limit value of the luminance in the display apparatus 20 is 2000 lumens or more, the controller 21 acquires a setting value concerning the light source and determines whether the setting value concerning the light source is 2000 lumens or less.

When the setting value is equal to or less than 2000 lumens, the controller 21 ends the processing in step S6.

When the setting value exceeds 2000 lumens, the controller 21 controls the light source 23 such that the luminance upper limit decreases to 2000 lumens or less and ends the processing in step S6. For specific control at this time, a method explained in a modification 5 below may be used.

According to the control explained above, when the user changes the setting of the display apparatus 20 against the contract, the luminance upper limit can be corrected to a value specified in the contract. Accordingly, it is possible to match a service allowed by the contract and the service actually provided by the display apparatus 20.

In the first embodiment, the display apparatus 20 is explained as being attached to the use space using the fixture 30. However, the display apparatus 20 may be installed in the use space without using the fixture 30.

### Modification 1

A modification 1 is an embodiment in which the display system 1 is changed to acquire the use form information via identification information of the fixture 30 in the first embodiment. Hereinafter, the modification 1 is explained. In the following explanation, explanation is sometimes omitted about portions common to the first embodiment.

FIG. 7 illustrates a configuration example including the display system 1 according to the modification 1. The display apparatus 20 includes a machine-readable media 26. The machine-readable media 26 is, for example, an IC tag. The machine-readable media 26 can transmit information to the reading device via wireless communication. The wireless communication is, for example, near field communication. In the machine-readable media 26, a display apparatus ID and an IP address of the display apparatus 20 are stored.

Similarly, the fixture 30 includes a machine-readable media 31. The machine-readable media 31 is, for example, an IC tag. The machine-readable media 31 can transmit information to the reading device via wireless communication. The wireless communication is, for example, near field communication. A fixture ID is stored in the machine-readable media 31. The fixture ID is identification information indicating the fixture 30.

The terminal 60 includes a not-illustrated reader. The reader can acquire information stored in a machine-readable media corresponding thereto via wireless communication. The wireless communication is, for example, near field communication.

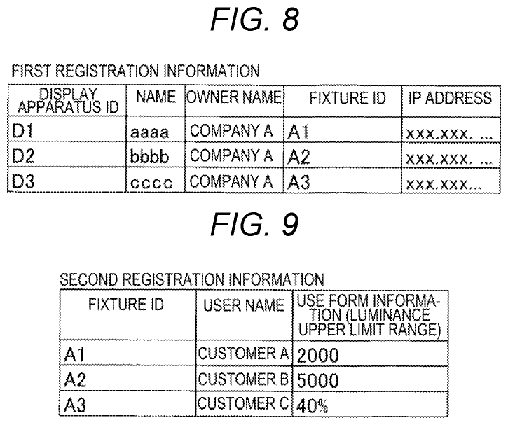

In FIGS. 8 and 9, configuration examples of the registration information 122 according to the modification 1 are illustrated. FIG. 8 illustrates a configuration example of first registration information included in the registration information 122. FIG. 9 illustrates a configuration example of second registration information included in the registration information 122.

The first registration information correlates, for each display apparatus, information concerning the display apparatus with a display apparatus ID. The information concerning the display apparatus includes a name of the display apparatus, an owner name of the display apparatus, a fixture ID of a fixture used to attach the display apparatus, and an IP address of the display apparatus. Identification information indicating the fixture 30 to which the display apparatus 20 is attached is third identification information.

The second registration information correlates, for each fixture, information concerning the fixture with a fixture ID. The information concerning the fixture includes a user name of a display apparatus attached using the fixture and use form information of the display apparatus attached using the fixture.

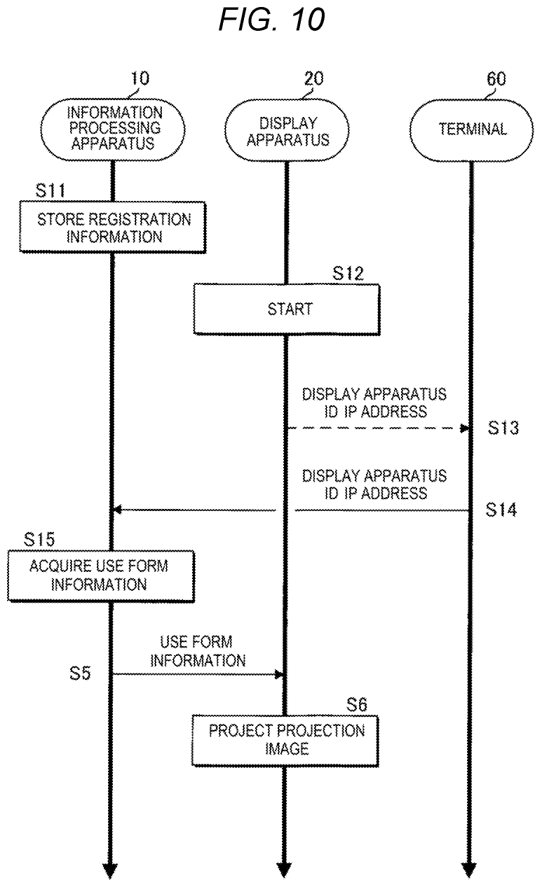

FIG. 10 is a flowchart illustrating an example of a flow of processing of the display system 1. This flowchart represents a display apparatus management method according to this modification. In the processing illustrated in FIG. 10, first, in step S11, the information processing apparatus 10 stores the registration information 122 in the storage device 12. Step S11 is a first storage step.

A specific execution procedure in step S11 can be optionally designed based on a publicly-known technique or the like. A specific example is explained below. First, the owner of the display apparatus 20 logs in to the information processing apparatus 10 via the terminal 60. Subsequently, the owner inputs information concerning a plurality of display apparatuses 20 to the information processing apparatus 10 as the registration information 122 via the terminal 60. The information processing apparatus 10 stores the input information as the registration information 122. As explained above, step S11 includes a step of storing, with the information processing apparatus 10, the identification information indicating the fixture 30 and the use form information in correlation with each other and a step of storing, with the information processing apparatus 10, the identification information indicating the display apparatus 20 and the identification information indicating the fixture 30 in correlation with each other.

Here, the owner does not need to manually input the fixture ID. For example, the owner may input the fixture ID to the terminal 60 by reading information from the machine-readable media 31 of the fixture 30 using the reader of the terminal 60.

Similarly, the owner does not need to manually input the display apparatus ID and the IP address of the display apparatus. For example, the owner may input the display apparatus ID and the IP address to the terminal 60 by reading information from the machine-readable media 26 of the display apparatus 20 using the reader of the terminal 60.

Subsequently, in step S12, the display apparatus 20 starts. This step S12 is executed, for example, like step S2 in the first embodiment.

Subsequently, in step S13, the terminal 60 reads the display apparatus ID and the IP address of the display apparatus 20 from the machine-readable media 26 of the display apparatus 20. In step S13, the terminal 60 does not need to execute any processing.

Subsequently, in step S14, the terminal 60 transmits the display apparatus ID and the IP address of the display apparatus 20 to the information processing apparatus 10. The information processing apparatus 10 receives the display apparatus ID and the IP address of the display apparatus 20.

Here, the terminal 60 may transmit attachment information in addition to the display apparatus ID and the IP address. The information processing apparatus 10 may receive the attachment information. The attachment information may be information indicating that work concerning the display apparatus 20 has been started. The work concerning the display apparatus 20 may be, for example, work of attaching the display apparatus 20 to the fixture 30. Alternatively, the work concerning the display apparatus 20 may be use of the display apparatus 20.

Subsequently, in step S15, the information processing apparatus 10 acquires use form information of the display apparatus 20. This is performed, for example, as explained below. First, the information processing apparatus 10 refers to the first registration information based on the display apparatus ID received in step S14 and acquires a fixture ID corresponding to the display apparatus 20. Subsequently, the information processing apparatus 10 refers to the second registration information based on the fixture ID and acquires use form information corresponding to the fixture 30.

The subsequent processing can be the same as the processing in the first embodiment. That is, the use form information is transmitted in step S5 and thereafter a projection image is projected in step S6.

In the first embodiment, the use form information is correlated with the display apparatus ID as illustrated in FIG. 5. For this reason, when work such as maintenance of the display apparatus occurs and the lent display apparatus is temporarily replaced, it is necessary to change the correlation between the display apparatus ID and the use form information stored in the registration information 122 before and after the work.

In contrast, in the modification 1, as illustrated in FIGS. 8 and 9, the use form information and the display apparatus ID are correlated with each other via the fixture ID. For this reason, for example, when the lent display apparatus is replaced, the existing use form information can be used as it is only by registering correlation between the display apparatus ID and the fixture ID anew.

With the configuration explained above, for example, when an administrator of a contract concerning the lending of the display apparatus 20 and an operator on the site who performs replacement work for the display apparatus 20 are different, since the operator on the site does not need to grasp information concerning the contract, the work on the site is simplified. The administrator of the contract does not need to update the information concerning the use form information and the time and effort for management are reduced.

In the modification 1 explained above, the terminal 60 is, for example, a terminal operated by the owner of the display apparatus 20. However, the operator of the terminal 60 is not limited to the owner. For example, the terminal 60 may be a terminal operated by the user of the display apparatus 20. The terminal 60 operated by the owner and the terminal 60 operated by the user may be respectively individually provided.

### Modification 2

A modification 2 is an embodiment in which a function of presenting another display apparatus as a substitute for a certain display apparatus is added to the display system 1 in the first embodiment or the modification 1. Hereinafter, the modification 2 is explained. In the following explanation, explanation is sometimes omitted about portions common to the first embodiment or the modification 1.

In the modification 2, a display apparatus has a function of transmitting notification information concerning a state of the display apparatus. The notification information is hereinafter referred to as “second notification information”.

The second notification information includes, for example, information concerning an abnormality of the display apparatus. The second notification information includes, for example, information indicating that an abnormality has occurred in the display apparatus. For example, the display apparatus may have a function of detecting an abnormality of the display apparatus. The display apparatus may have a function of, when detecting an abnormality, transmitting, as the second notification information, information indicating that the abnormality has been detected and details of the detected abnormality. A transmission destination is, for example, the information processing apparatus 10. Those skilled in the art can design, as appropriate, with reference to a publicly-known technique or the like, a specific configuration and processing for detecting an abnormality.

The second notification information may include, for example, information indicating that the luminance of the display apparatus has decreased. For example, the second notification information includes information indicating that a measurement value concerning the luminance of the display apparatus is smaller than a threshold relating to use form information. Those skilled in the art can optionally design a method of acquiring the measurement value concerning the luminance. A specific example of the method of acquiring the measurement value concerning the luminance is explained in a modification 3 below.

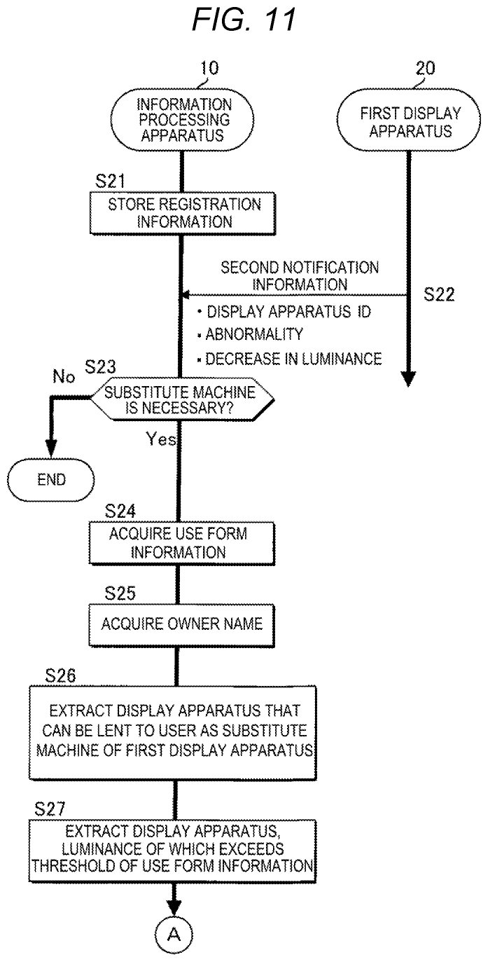

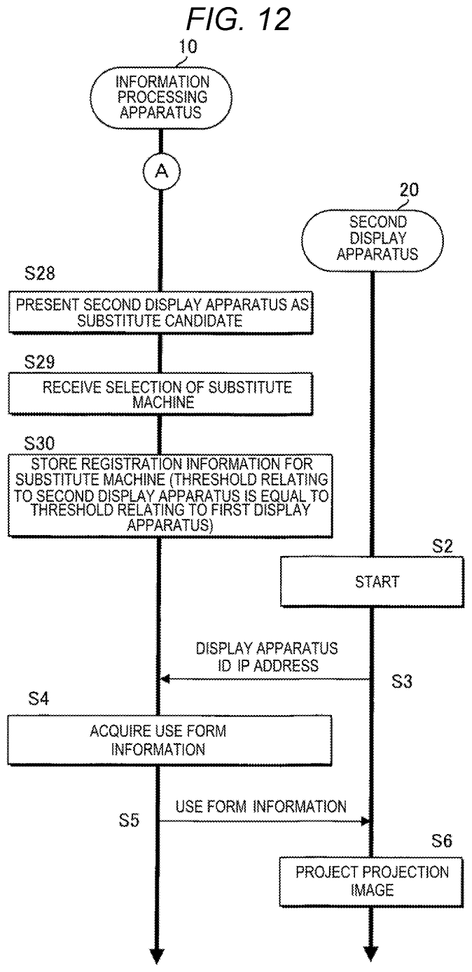

FIGS. 11 and 12 are flowcharts illustrating an example of a flow of processing of the display system 1 according to the modification 2. FIG. 11 illustrates a first portion of the flowchart and FIG. 12 illustrates a second portion of the flowchart. This flowchart represents a display apparatus management method according to the modification 2. In the processing in FIGS. 11 and 12, first, in step S21, the information processing apparatus 10 stores the registration information 122 in the storage device 12. Step S21 is the first storage step.

The registration information 122 in the modification 2 includes information concerning a plurality of display apparatuses. For example, the registration information 122 includes information concerning a first display apparatus and information concerning a second display apparatus.

Here, a case in which an abnormality has occurred in the first display apparatus is considered. In step S22, the first display apparatus transmits the second notification information to the information processing apparatus 10. For example, the second notification information includes a display apparatus ID of the first display apparatus and information concerning an abnormality of the first display apparatus. For example, the second notification information includes information indicating that the luminance of the display apparatus has decreased. The information processing apparatus 10 receives the second notification information from the first display apparatus.

Subsequently, in step S23, the information processing apparatus 10 determines whether a replacement display apparatus is necessary for the first display apparatus. Whether the replacement display apparatus is necessary is determined according to content of the second notification information, in particular, according to information concerning an abnormality of the first display apparatus. As an example, the information processing apparatus 10 may store a table that defines, in association with each of the types of conceivable abnormalities, whether a replacement display apparatus is necessary.

When a replacement display apparatus is unnecessary (step S23: NO), the information processing apparatus 10 ends the processing in FIGS. 11 and 12. When a replacement display apparatus is necessary (step S23: YES), in step S24, the information processing apparatus 10 acquires use form information concerning the first display apparatus. This processing is performed, for example, as in step S4 or step S15.

Subsequently, in step S25, the information processing apparatus 10 acquires an owner name of the first display apparatus. The owner name of the first display apparatus can be acquired by referring to the registration information 122 based on, for example, the display apparatus ID.

Subsequently, in step S26, the information processing apparatus 10 extracts one or more display apparatuses that can be lent to the user as the replacement display apparatus of the first display apparatus. The one or more display apparatuses that can be lent to the user as the replacement display apparatus of the first display apparatus are display apparatuses managed as stocks by the owner. The one or more display apparatuses that can be lent to the user as the replacement display apparatus of the first display apparatus are extracted by, for example, referring to registration information and acquiring a display apparatus, a user name of which matches the owner name acquired in step S25.

Subsequently, in step S27, the information processing apparatus 10 further extracts a display apparatus that can be lent to the user as the replacement display apparatus of the first display apparatus, the luminance of the display apparatus exceeding a threshold of the use form information relating to the first display apparatus, among the one or more display apparatuses that can be lent to the user as the replacement display apparatus of the first display apparatus. Here, a display apparatus that can be lent to the user as the replacement display apparatus of the first display apparatus and satisfies conditions of the use form information relating to the first display apparatus is the second display apparatus. The threshold of the use form information relating to the first display apparatus is the first threshold. For example, when the first display apparatus is a display apparatus corresponding to the display apparatus ID “D1” in FIG. 5, since the threshold of the use form information relating to the first display apparatus is 2000 lumens, a display apparatus having luminance exceeding 2000 lumens is further extracted among the one or more display apparatuses that can be lent to the user as the replacement display apparatus of the first display apparatus.

Here, those skilled in the art can optionally design a method of acquiring the luminance of the display apparatus that can be lent to the user as the replacement display apparatus of the first display apparatus. As an example, the luminance of the display apparatus that can be lent to the user as the replacement display apparatus of the first display apparatus is represented by a luminance upper limit of the display apparatus that can be lent to the user as the replacement display apparatus of the first display apparatus. For example, maximum luminance in the specifications of each display apparatus that can be lent to the user as the replacement display apparatus of the first display apparatus may be stored in the registration information 122 in correlation with the display apparatus ID as the luminance of the display apparatus. Alternatively, a luminance upper limit measured for each display apparatus that can be lent to the user as the replacement display apparatus of the first display apparatus may be stored in the registration information 122 as the luminance of the display apparatus that can be lent to the user as the replacement display apparatus of the first display apparatus. Alternatively, the luminance upper limit of the display apparatus that can be lent to the user as the replacement display apparatus of the first display apparatus may be calculated based on an operating time of each display apparatus that can be lent to the user as the replacement display apparatus of the first display apparatus.

Subsequently, in step S28, the information processing apparatus 10 presents, as a candidate replacement display apparatus for the first display apparatus, the second display apparatus extracted in step S27. When a plurality of second display apparatuses are present, the information processing apparatus 10 may present a list of the second display apparatuses.

Those skilled in the art can optionally design a specific form of the presentation. For example, the information processing apparatus 10 may present a display apparatus ID of the second display apparatus by transmitting the display apparatus ID to the terminal 60. In that case, the terminal 60 may display the received display apparatus ID of the second display apparatus. Alternatively, the information processing apparatus 10 may present the display apparatus ID of the second display apparatus by displaying the display apparatus ID on a display apparatus that is an example of the output device 15 of the information processing apparatus 10.

The information processing apparatus 10 may output the display apparatus ID of the first display apparatus and the second notification information. For example, the information processing apparatus 10 may transmit these kinds of information to the terminal 60. The terminal 60 may receive and display these kinds of information.

In one example, the terminal 60 displays the display apparatus ID of the first display apparatus, an abnormality being detected in the first display apparatus, and a list of display apparatus IDs of the second display apparatuses.

As explained above, the information processing apparatus 10 presents the second display apparatus as the candidate replacement display apparatus for the first display apparatus when receiving the second notification information concerning a state of the first display apparatus and when the luminance of the second display apparatus exceeds the threshold of the use form information.

Subsequently, in step S29, the information processing apparatus 10 receives selection of a replacement display apparatus. This processing is performed, for example, as explained below. The terminal 60 displays display apparatus IDs of one or more second display apparatuses. The owner selects any one of the plurality of second display apparatuses as a replacement display apparatus. The terminal 60 receives the selection and transmits a display apparatus ID of the selected second display apparatus to the information processing apparatus 10. The information processing apparatus 10 receives the display apparatus ID to thereby receive the selection of the replacement display apparatus.

Subsequently, in step S30, the information processing apparatus 10 stores registration information for the selected second display apparatus, that is, the replacement display apparatus. Step S30 is a second storage step. For example, the use form information is updated for the second display apparatus. Here, the use form information of the second display apparatus is updated to be the same as the use form information of the first display apparatus.

For example, the information processing apparatus 10 stores a threshold of the luminance of the second display apparatus as the use form information of the second display apparatus. This threshold is, for example, a threshold indicating a boundary of a range concerning a luminance upper limit of the second display apparatus. This threshold is the first threshold. As explained above, a value of the first threshold relating to the second display apparatus is equal to a value of the first threshold relating to the first display apparatus.

According to the processing explained above, since an appropriate candidate replacement display apparatus is automatically presented, the owner does not need to check details of each display apparatus and extract a candidate replacement display apparatus. The same contract conditions as those of the original display apparatus are implemented for the replacement display apparatus.

Here, although not illustrated in FIGS. 11 and 12, the owner or the operator on the site may detach the first display apparatus from the fixture 30. Thereafter, the owner or the operator on the site may attach the replacement display apparatus, that is, the selected second display apparatus to the fixture 30.

Thereafter, the replacement display apparatus, that is, the selected second display apparatus is used. Processing relating to use can be the same as, for example, steps S2 to S6 in the first embodiment. For example, the replacement display apparatus projects the projection image 50 based on the use form information.

According to the modification 2 explained above, the owner of the display apparatus can quickly provide the replacement display apparatus when an abnormality occurs in the display apparatus being lent. For this reason, a loss of an opportunity to provide a service is suppressed.

The owner of the display apparatus can automatically acquire an appropriate list of candidate replacement display apparatuss when an abnormality occurs in the display apparatus being lent. In particular, since only a display apparatus conforming to use form information relating to a current contract is presented as a candidate replacement display apparatus, the time and effort to investigate a display apparatus that can provide a service equal to or higher than a service desired by the user are reduced.

The owner of the display apparatus can quickly provide a replacement display apparatus when the luminance of the display apparatus decreases. Therefore, the satisfaction of the user is improved.

### Modification 3

A modification 3 is an embodiment in which the display system 1 is changed to detect deterioration over time of a display apparatus in the first embodiment, the modification 1, or the modification 2. Hereinafter, the modification 3 is explained. In the following explanation, explanation is sometimes omitted about portions common to the first embodiment, the modification 1, or the modification 2.

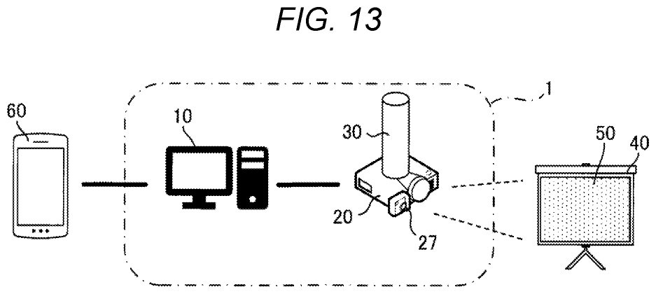

FIG. 13 illustrates a configuration example including the display system 1 according to the modification 3. The display apparatus 20 includes an imaging device 27. The imaging device 27 is, for example, a camera. The imaging device 27 is configured to be able to capture the projection image 50 projected by the display apparatus 20.

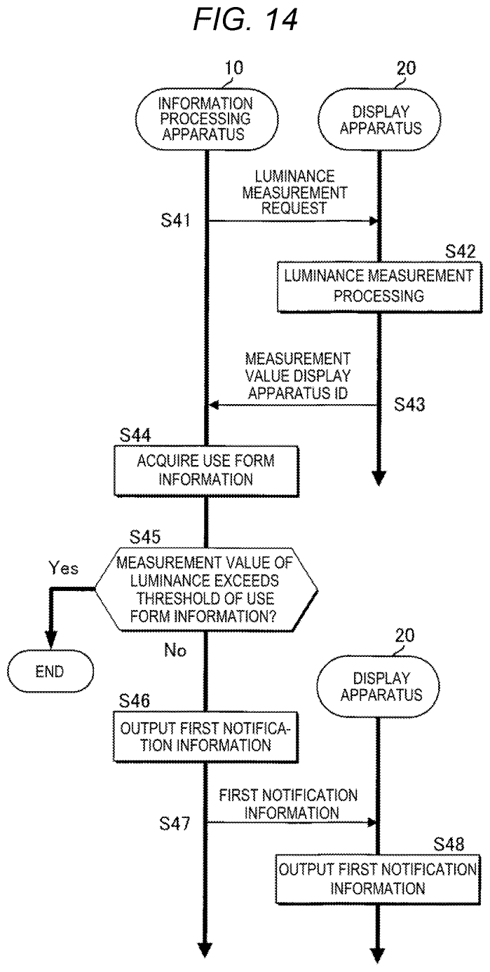

FIG. 14 is a flowchart illustrating an example of a flow of processing of the display system 1 according to the modification 3. This flowchart represents a display apparatus management method according to the modification 3. Execution of the processing in FIG. 14 is started periodically or in response to a specific instruction after an operation of the display apparatus 20 is started.

In the processing in FIG. 14, first, in step S41, the information processing apparatus 10 transmits a luminance measurement request to the display apparatus 20. The display apparatus 20 receives the luminance measurement request.

Subsequently, in step S42, the display apparatus 20 executes luminance measurement processing. The luminance measurement processing is executed, for example, as explained below. First, the display apparatus 20 projects a white image, the luminance of which is set to a maximum value, as the projection image 50. The display apparatus 20 captures the white image using the imaging device 27. The display apparatus 20 calculates an average value of luminance for a region corresponding to the white image in the captured image. It can be said that the calculated average value is an example of a measurement value concerning the luminance.

Subsequently, in step S43, the display apparatus 20 transmits a display apparatus ID and the measurement value to the information processing apparatus 10. The information processing apparatus 10 receives the display apparatus ID and the measurement value. The information processing apparatus 10 stores the received display apparatus ID and the received measurement value in the storage device 12 in correlation with each other. The display apparatus ID and the measurement value may be added to, for example, the registration information 122.

Subsequently, in step S44, the information processing apparatus 10 acquires use form information relating to the display apparatus ID received in step S43. Here, the use form information is, for example, a threshold of the luminance of the display apparatus. This threshold is the first threshold.

Subsequently, in step S45, the information processing apparatus 10 determines whether the measurement value of the luminance exceeds the first threshold. When the measurement value of the luminance exceeds the first threshold (step S45: YES), the information processing apparatus 10 ends the processing in FIG. 14.

When the measurement value of the luminance does not exceed the first threshold (step S45: NO), in step S46, the information processing apparatus 10 outputs first notification information. The first notification information is information indicating that the display apparatus 20 does not conform to the use form information. More specifically, the first notification information may be information indicating that the light source 23 of the display apparatus 20 is deteriorated. An output destination of the first notification information is, for example, the terminal 60. Alternatively, the output destination of the first notification information is, for example, a display device provided in the information processing apparatus 10. The output destination of the first notification information may be both of the terminal 60 and the display device.

Subsequently, in step S47, the information processing apparatus 10 transmits the first notification information to the display apparatus 20. The display apparatus 20 receives the first notification information.

Subsequently, in step S48, the display apparatus 20 outputs the first notification information. An output destination of the first notification information is, for example, the terminal 60. Alternatively, the output destination of the first notification information is, for example, the display 24 provided in the display apparatus 20. The output destination of the first notification information may be both of the terminal 60 and the display 24.

As explained above, when the measurement value concerning the luminance of the display apparatus 20 is smaller than the first threshold, the display apparatus 20 or the information processing apparatus 10 outputs the first notification information. In general, the luminance of the display apparatus 20 decreases as the display apparatus 20 deteriorates over time. In particular, the luminance upper limit decreases. Here, according to the modification 3, since the first notification information is output when the luminance decreases and does not conform to the use form information, the owner and the user can learn that handling work is necessary. For example, procedures such as update of a contract, change of a model, and maintenance of a product can be started between the owner and the user.

In the example illustrated in FIG. 14, the first notification information is output in both of steps S46 and S48. However, one of the steps can be omitted. For example, step S46 may be omitted. Alternatively, steps S47 and S48 may be omitted.

In the example illustrated in FIG. 14, steps S44 and S45 are executed in the information processing apparatus 10. However, the processing in steps S44 and S45 may be executed in the display apparatus 20. In that case, the first notification information may be transmitted from the display apparatus 20 to the information processing apparatus 10.

When the first notification information is output to the terminal 60, the terminal 60 may be a terminal operated by the owner of the display apparatus 20 or may be a terminal operated by the user of the display apparatus 20.

Instead of the imaging device 27, another sensor may be used. For example, the display apparatus 20 may include, on an optical path from the light source 23 to the display 24 in the apparatus, a sensor that measures a light flux. The measurement value concerning the luminance of the display apparatus 20 can also be acquired by the sensor.

### Modification 4

A modification 4 is an embodiment in which the display system 1 is changed to execute verification concerning the use form information according to, for example, a change of the contract in any one of the first embodiment and the modifications 1 to 3. Hereinafter, the modification 4 is explained. In the following explanation, explanation is sometimes omitted about portions common to any one of the first embodiment and the modifications 1 to 3.

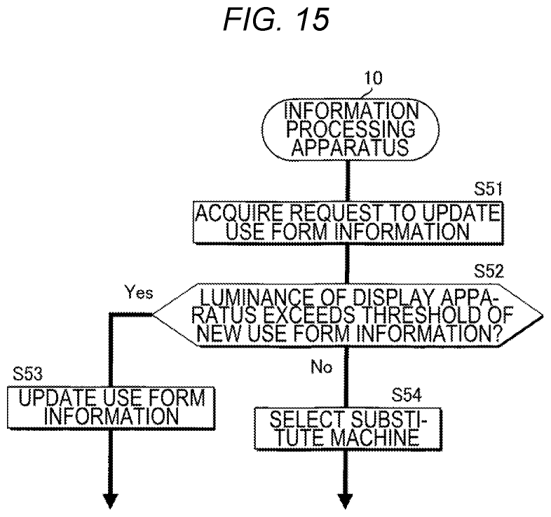

FIG. 15 is a flowchart illustrating an example of a flow of processing of the display system 1 according to the modification 4. This flowchart represents a display apparatus management method according to the modification 4. The processing in FIG. 15 is executed, for example, when use form information is changed for any display apparatus.

First, in step S51, the information processing apparatus 10 receives a request to update the use form information. The request to update the use form information includes a display apparatus ID of a display apparatus that is a target of the update request and new use form information.

Subsequently, in step S52, the information processing apparatus 10 determines whether the luminance of the display apparatus exceeds a threshold of the new use form information. The threshold of the new use form information is the first threshold.

When the luminance of the display apparatus exceeds the threshold of the new use form information (step S52: YES), in step S53, the information processing apparatus 10 updates the use form information. That is, the information processing apparatus 10 updates the use form information of the display apparatus to the new use form information in the registration information 122.

When the luminance of the display apparatus does not exceed the threshold of the new use form information (step S52: NO), in step S54, the information processing apparatus 10 selects a replacement display apparatus. Details of this processing are not illustrated in FIG. 15. This processing is executed, for example, using the new use form information, for example, in the same manner as in step S24 and subsequent steps in FIGS. 11 and 12.

According to the modification 4, when the use form information is changed according to, for example, a change of a contract and, accordingly, the display apparatus does not conform to the new use form information, the owner can appropriately select a replacement display apparatus.

For example, it is assumed that a luminance upper limit of a display apparatus lent to the user is 3000 lumens. It is assumed that a threshold of a luminance upper limit range indicated by use form information of the display apparatus is 2000 lumens. It is assumed that a contract of the display apparatus is updated and the threshold of the luminance upper limit range is changed to 4000 lumens. In such a case, since luminance is insufficient in the display apparatus, the display apparatus cannot conform to the use form information. In such a case, according to the modification 4, the owner can receive presentation of an appropriate candidate replacement display apparatus and can appropriately select a replacement display apparatus. For this reason, it is possible to prevent the satisfaction of the user from decreasing.

### Modification 5

A modification 5 is an embodiment in which a function of, when setting concerning the luminance of a display apparatus is excessive with respect to use form information, appropriately changing the setting is added in any of the first embodiment and the modifications 1 to 4. Hereinafter, the modification 5 is explained. In the following explanation, explanation is sometimes omitted about portions common to any of the first embodiment and the modifications 1 to 4.

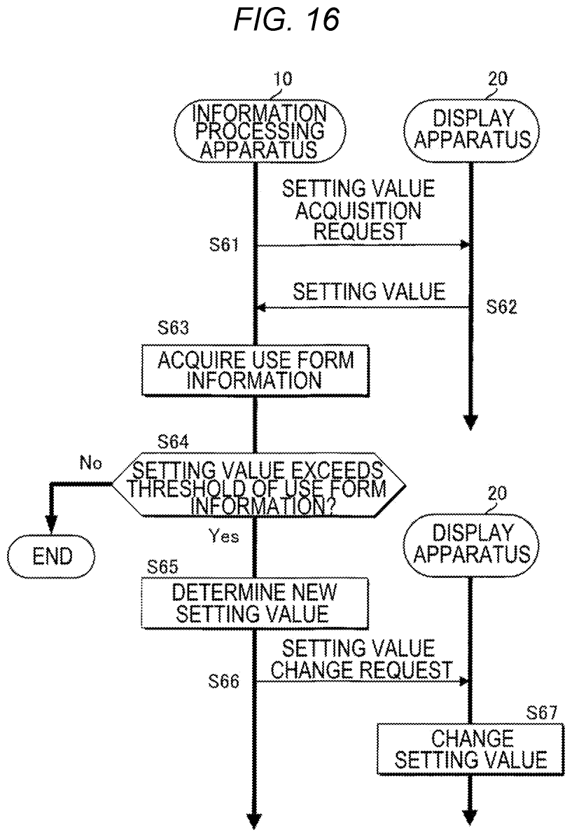

FIG. 16 is a flowchart illustrating an example of a flow of processing of the display system 1 according to the modification 5. This flowchart represents a display apparatus management method according to the modification 5. Execution of the processing in FIG. 16 is started periodically or in response to a specific instruction after an operation of the display apparatus 20 is started.

First, in step S61, the information processing apparatus 10 transmits a setting value acquisition request to the display apparatus 20. The display apparatus 20 receives the setting value acquisition request. In step S62, the display apparatus 20 transmits a setting value to the information processing apparatus 10. The information processing apparatus 10 receives the setting value. The setting value is, for example, a setting value concerning the light source 23.

Subsequently, in step S63, the information processing apparatus 10 acquires use form information of the display apparatus 20. In step S64, the information processing apparatus 10 determines whether the setting value exceeds a threshold of the use form information. The threshold of the use form information is the second threshold. When the setting value does not exceed the threshold of the use form information (step S64: NO), the information processing apparatus 10 ends the processing in FIG. 16.

When the setting value exceeds the threshold of the use form information (step S64: YES), in step S65, the information processing apparatus 10 determines a new setting value. The new setting value is determined according to the use form information to conform to the use form information. For example, the new setting value is a value equal to or smaller than the threshold of the use form information. When a threshold of a luminance upper limit range indicated by the use form information of the display apparatus is 2000 lumens, the new setting value is determined to be 2000 lumens or a value smaller than 2000 lumens.

Subsequently, in step S66, the information processing apparatus 10 transmits a setting value change request to the display apparatus 20. The display apparatus 20 receives the setting value change request. The setting value change request includes an instruction to change the setting value and a new setting value. In response to the setting value change request, the display apparatus 20 changes the setting value in step S67.

As explained above, when the setting value concerning the light source 23 of the display apparatus 20 exceeds the threshold of the use form information, the display apparatus 20 changes the setting value to the threshold or smaller.

According to the modification 5 explained above, when the setting concerning the luminance of the display apparatus is excessive with respect to the use form information, the setting can be changed to an appropriate state. For example, when the setting value is an excessive value exceeding a setting value of the contract because of, for example, erroneous operation of the user, the setting value can be changed to a value within the range of the contract. As explained above, it is possible to prevent a service different from a service desired by the user from being provided.

### Modification 6

A modification 6 is an embodiment further including specific processing for changing a setting value concerning the light source 23 of the display apparatus 20 in any of the first embodiment and the modifications 1 to 5. Hereinafter, the modification 6 is explained. In the following explanation, explanation is sometimes omitted about portions common to any of the first embodiment and the modifications 1 to 5.

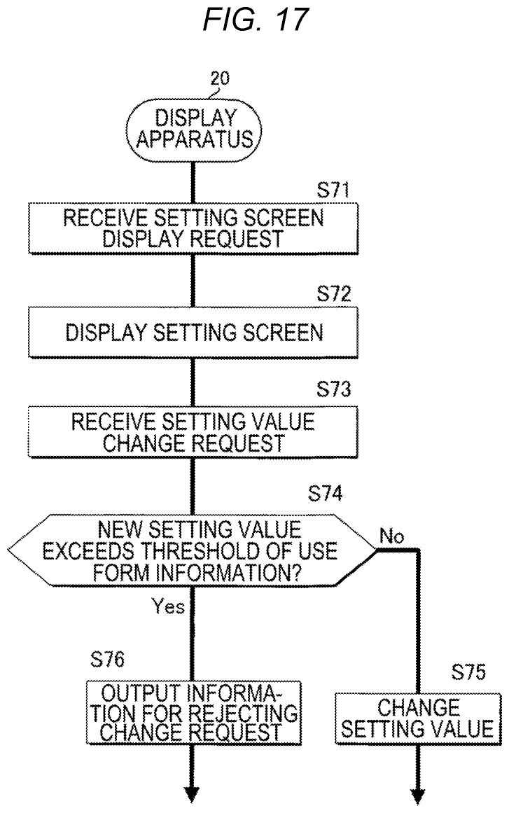

FIG. 17 is a flowchart illustrating an example of a flow of processing of the display apparatus 20 according to the modification 6. This flowchart represents a display apparatus management method according to the modification 6. The processing in FIG. 17 is started in response to the display apparatus 20 receiving a setting screen display request in step S71.

The setting screen display request is a request for displaying a setting screen for setting a setting value concerning the light source 23 of the display apparatus 20. In response to the setting screen display request, the display apparatus 20 displays the setting screen in step S72.

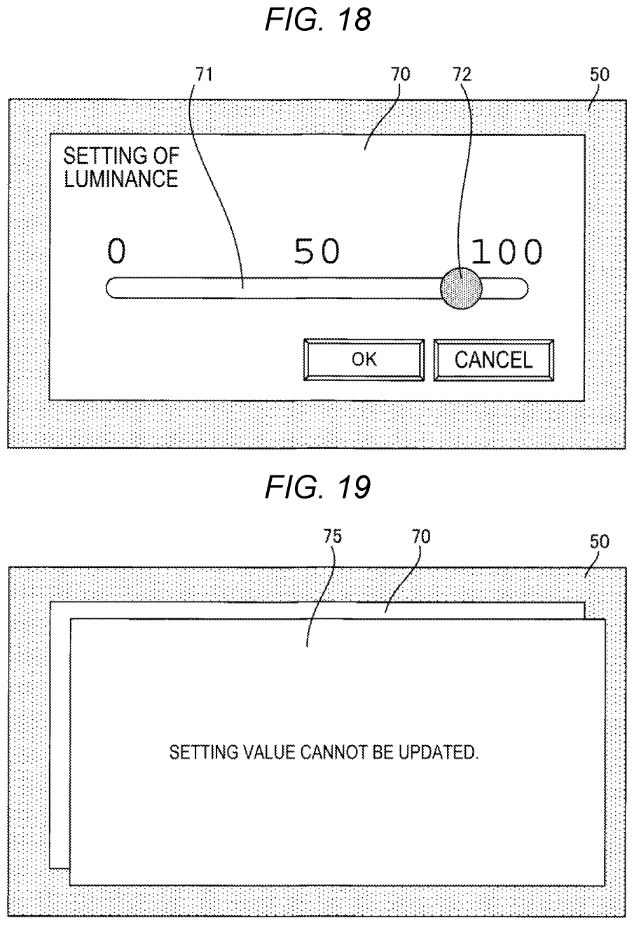

FIG. 18 is a configuration example of a setting screen 70 according to the modification 6. The setting screen 70 is displayed, for example, in a part or the entire area of the projection image 50. The setting screen 70 includes a setting range bar 71 and a setting handle 72.

Subsequently, in step S73, the display apparatus 20 receives a setting value change request. The user can input the setting value change request via the setting screen 70. For example, the user can input a new setting value by changing the position of the setting handle 72 on the setting range bar 71 via not-illustrated input means of the display apparatus 20. After moving the setting handle 72 to a position corresponding to a desired setting value, the user can input the setting value change request by operating an OK button.

In response to receiving the setting value change request, in step S74, the display apparatus 20 determines whether the new setting value exceeds a threshold of use form information. The threshold of the use form information is the second threshold.

When the new setting value does not exceed the threshold of the use form information (step S74: NO), in step S75, the display apparatus 20 updates the setting value. Accordingly, the setting value changes to a value desired by the user. Although not illustrated, after step S75, the display apparatus 20 may display a screen indicating that the setting value has been changed. The display apparatus 20 may transmit the new setting value to the information processing apparatus 10.

When the new setting value exceeds the threshold of the use form information (step S74: YES), in step S76, the display apparatus 20 outputs information for rejecting the change request. The information for rejecting the change request is displayed on, for example, a change rejection screen.

FIG. 19 is a configuration example of a change rejection screen 75 according to the modification 6. The change rejection screen 75 is displayed, for example, in a part or the entire area of the projection image 50. In the example illustrated in FIG. 19, the change rejection screen 75 displays a message “the setting value cannot be updated” as information for rejecting the change. After step S76, the processing in FIG. 17 ends. In this case, the setting value of the display apparatus 20 is not updated.

As explained above, in the modification 6, when receiving the change request for changing the setting value concerning the light source 23 of the display apparatus 20 to a value exceeding the threshold of the use form information, the display apparatus 20 outputs the information for rejecting the change request.

According to the modification 6 explained above, when a setting value not conforming to the contract is instructed by, for example, erroneous operation of the user, since a change of the setting value is rejected, it is possible to prevent a service different from a service desired by the user from being provided.

In the modification 6, the processing in FIG. 17 is executed by the display apparatus 20. However, the processing in FIG. 17 can also be executed by the information processing apparatus 10. In that case, the setting screen 70 and the change rejection screen 75 are displayed on, for example, the display device provided in the information processing apparatus 10. After step S75, the information processing apparatus 10 may transmit, to the display apparatus 20, the same setting value change request as that transmitted in step S66. In this case, the information for rejecting the change request is output by the information processing apparatus 10.

### Modification 7

A modification 7 is an embodiment further including specific processing for changing a setting value concerning the light source 23 of the display apparatus 20 in any of the first embodiment and the modifications 1 to 5. Hereinafter, the modification 7 is explained. In the following explanation, explanation is sometimes omitted about portions common to any of the first embodiment and the modifications 1 to 5.

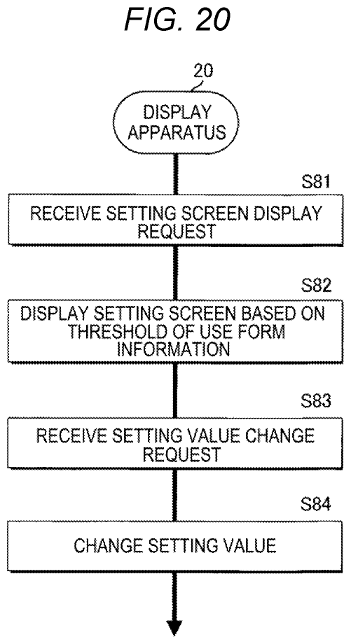

FIG. 20 is a flowchart illustrating an example of a flow of processing of the display apparatus 20 according to the modification 7. The flowchart illustrated in FIG. 20 represents a display apparatus management method according to the modification 7. The processing in FIG. 20 is started in response to the display apparatus 20 receiving a setting screen display request in step S81.

The setting screen display request is a request for displaying a setting screen. The setting screen is a screen for setting a setting value concerning the light source 23 of the display apparatus 20. In response to the setting screen display request, the display apparatus 20 displays the setting screen in step S82. The setting screen is determined based on a threshold of use form information. For example, a setting screen having different content is displayed according to the threshold of the use form information. That is, the setting screen is displayed based on the threshold of the use form information. The threshold of the use form information is the second threshold.

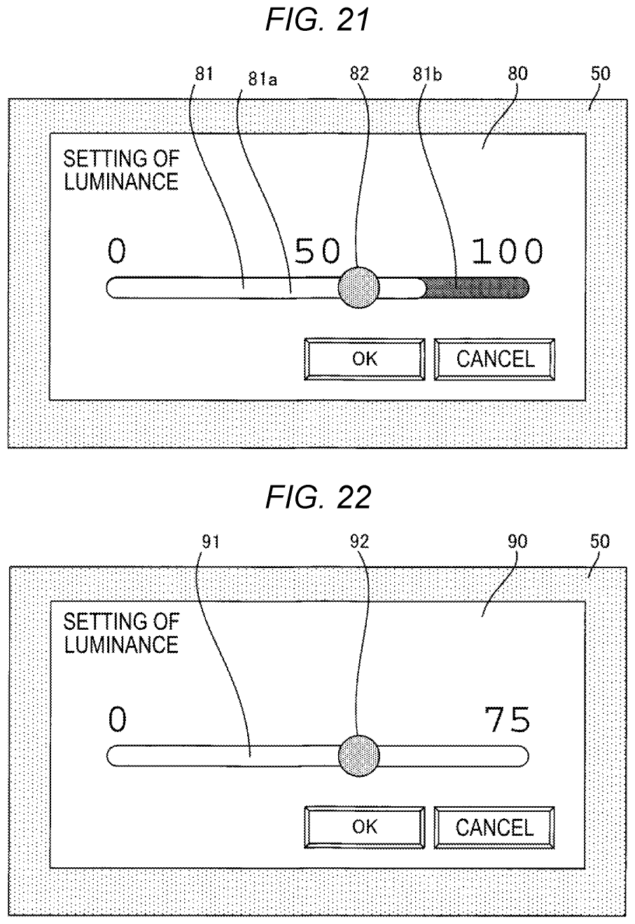

FIG. 21 is a configuration example of a setting screen 80 serving as the setting screen according to the modification 7. The setting screen 80 is displayed, for example, in a part or the entire area of the projection image 50. The setting screen 80 includes a setting range bar 81 and a setting handle 82.

The setting range bar 81 includes a permission range 81a and a prohibition range 81b. The permission range 81a is a range in which a setting value is equal to or smaller than the threshold of the use form information in a range of the setting value indicated by the setting range bar 81. The prohibition range 81b is a range in which the setting value exceeds the threshold of the use form information in the range of the setting value indicated by the setting range bar 81. The permission range 81a and the prohibition range 81b are displayed, for example, in different forms from each other and, as a specific example, in different colors from each other.

The setting handle 82 can be moved only within the permission range 81a in the setting range bar 81. That is, even when operation of moving the setting handle 82 to the prohibition range 81b is performed on the setting screen 80, the display apparatus 20 causes the setting handle 82 to stay within the permission range 81a.

As explained above, the setting screen 80 is configured to receive input of a new setting value within the range in which the setting value is equal to or smaller than the threshold of the use form information but not to receive input of a new setting value in the range in which the setting value exceeds the threshold of the use form information.

FIG. 22 is a configuration example of a setting screen 90 serving as another setting screen according to the modification 7. The setting screen 90 is displayed, for example, in a part or the entire area of the projection image 50. The setting screen 90 includes a setting range bar 91 and a setting handle 92.

The setting range bar 91 is displayed for a range in which a setting value is equal to or smaller than the threshold of the use form information. In the example illustrated in FIG. 22, the maximum value of setting values that can be input is “75%”. This corresponds to, for example, a case in which the threshold of the use form information is 75%. A display unit in the setting range bar 91 is not limited to the ratio such as % and may be lumen or another unit.

As explained above, since the setting range bar 91 receives input only within the range in which the setting value is equal to or smaller than the threshold of the use form information, a setting value exceeding the threshold of the use form information cannot be input.

After step S82, in step S83, the display apparatus 20 receives a setting value change request in the same manner as in step S73. In response to receiving the setting value change request, in step S84, the display apparatus 20 updates the setting value of the display apparatus 20. Accordingly, the setting value changes to a value desired by the user. Although not illustrated, after step S84, the display apparatus 20 may display a screen indicating that the setting value has been changed. The display apparatus 20 may transmit the new setting value to the information processing apparatus 10.

According to the modification 7 explained above, a setting value not conforming to the contract is prevented from being input by, for example, erroneous operation of the user.

In the modification 7, the processing in FIG. 20 is executed by the display apparatus 20. However, the processing in FIG. 20 can also be executed by the information processing apparatus 10. In this case, the setting screen 80 and the setting screen 90 are displayed on, for example, the display device provided in the information processing apparatus 10. After step S84, the information processing apparatus 10 may transmit, to the display apparatus 20, the same setting value change request as that transmitted in step S66.

Those skilled in the art can optionally add, change, or delete elements in the first embodiment and the modifications. For example, the information processing apparatus 10 can include a plurality of computers connected via a communication network.

### Appendices

A summary of the present disclosure is appended below.

### Appendix 1

A display apparatus management method including: storing, with a first information processing apparatus, at least one of first identification information and second identification information and use form information; connecting, with the first information processing apparatus, to a first display apparatus via a communication network; transmitting, with the first information processing apparatus, the use form information to the first display apparatus based on at least one of the first identification information and the second identification information; and causing the first display apparatus to project a projection image based on the use form information, wherein the first identification information is identification information indicating the first display apparatus, the second identification information is identification information indicating a user of the first display apparatus, the use form information is correlated with the at least one of the first identification information and the second identification information, and the use form information is information for limiting at least a part of a use form of a function of the first display apparatus.

With the management method according to Appendix 1, since the first display apparatus projects the projection image based on the use form information, which is the information for limiting at least a part of the use form of the function of the first display apparatus, it is possible to match a service desired by the user under a contract and a service actually provided by a display apparatus.

### Appendix 2

The display apparatus management method described in Appendix 1, wherein the storing includes: storing, with the first information processing apparatus, third identification information and the use form information in correlation with each other; and storing, with the first information processing apparatus, the first identification information and the third identification information in correlation with each other, and the third identification information is identification information indicating a fixture for installing the first display apparatus in a use space.

With the management method according to Appendix 2, since the third identification information, which is the identification information indicating the fixture, and the use form information are stored in correlation with each other and the third identification information and the first identification information are stored in correlation with each other, when a lent display apparatus is replaced, it is possible to reduce a load of setting work for a display apparatus installed anew. Specifically, by updating the first identification information correlated with the third identification information, it is possible to correlate the first identification information and the use form information.

### Appendix 3

The display apparatus management method described in Appendix 1 or 2, wherein the use form information includes a first threshold that is a threshold of luminance of the first display apparatus, and the method further includes outputting first notification information with the first display apparatus or the first information processing apparatus when a measurement value concerning the luminance of the first display apparatus is smaller than the first threshold.

With the management method according to Appendix 3, when the luminance of the display apparatus decreases and does not conform to the use form information, since the first notification information is output, an owner or the user can learn that work of changing setting of the relevant display apparatus or work of replacing the display apparatus is necessary.

### Appendix 4

The display apparatus management method described in any one of Appendices 1 to 3, wherein the use form information includes a second threshold that is a threshold of luminance of the first display apparatus, and the method further includes, when a setting value concerning a light source of the first display apparatus exceeds the second threshold, changing the setting value to the second threshold or smaller with the first display apparatus.

With the management method according to Appendix 4, when setting concerning the luminance of the display apparatus is excessive with respect to the use form information, by changing the setting to an appropriate state, it is possible to match the service desired by the user under the contract and the service actually provided by the display apparatus. For example, when the setting value is an excessive value exceeding a setting value of the contract because of, for example, erroneous operation of the user, the setting value can be set to a value within the range of the contract.

### Appendix 5

The display apparatus management method described in any one of Appendices 1 to 4, wherein the use form information includes a second threshold that is a threshold of luminance of the first display apparatus, and the method further includes, when a change request for changing a setting value concerning a light source of the first display apparatus to a value exceeding the second threshold is received by the first display apparatus or the first information processing apparatus, outputting, with the first display apparatus or the first information processing apparatus, information for rejecting the change request.

With the management method according to Appendix 5, when a change request for a setting value not conforming to the use form information is received because of, for example, erroneous operation of the user, since the change of the setting value is rejected, it is possible to match the service desired by the user and the service actually provided by the display apparatus.

### Appendix 6

The display apparatus management method described in any one of Appendices 1 to 5, wherein the use form information includes a second threshold that is a threshold of luminance of the first display apparatus, and the method further includes displaying, with the first display apparatus or the first information processing apparatus, a setting screen based on the second threshold.

With the management method according to Appendix 6, by displaying the setting screen based on the second threshold, it is possible to prevent a setting value not conforming to the use form information from being input by, for example, erroneous operation of the user and it is possible to match the service desired by the user and the service actually provided by the display apparatus.

### Appendix 7

A display apparatus management method including: storing, with a first information processing apparatus, at least one of first identification information and second identification information; connecting, with the first information processing apparatus, to a first display apparatus and a second display apparatus via a communication network; storing, with the first information processing apparatus, a first threshold that is a threshold of luminance of the first display apparatus; and presenting the second display apparatus as a candidate replacement display apparatus for the first display apparatus when the first information processing apparatus receives second notification information concerning a state of the first display apparatus and when luminance of the second display apparatus exceeds the first threshold, wherein the first identification information is identification information indicating the first display apparatus, the second identification information is identification information indicating a user of the first display apparatus, and the first threshold is correlated with the at least one of the first identification information and the second identification information.

With the management method according to Appendix 7, when the second notification information concerning the state of the first display apparatus is received by the first information processing apparatus and when the luminance of the second display apparatus exceeds the first threshold, since the second display apparatus is presented as the candidate replacement display apparatus for the first display apparatus, an owner can reduce a load of work of extracting the candidate replacement display apparatus for the first display apparatus.

### Appendix 8

The display apparatus management method described in Appendix 7, further including: storing, with the first information processing apparatus, a threshold of luminance of the second display apparatus; and projecting, with the second display apparatus, a projection image based on the threshold of the luminance of the second display apparatus, wherein the threshold of the luminance of the second display apparatus is equal to a value of the first threshold.

With the management method according to Appendix 8, by projecting, with the second display apparatus, the projection image based on the threshold of the luminance of the second display apparatus equal to the value of the first threshold, it is possible to match a service desired by the user under a contract and a service provided by a replacement display apparatus.

### Appendix 9

The display apparatus management method described in Appendix 7 or 8, wherein the second notification information includes information concerning an abnormality of the first display apparatus.

With the management method according to Appendix 9, since the second notification information includes the information concerning the abnormality of the first display apparatus, when an abnormality occurs in a display apparatus being lent, an owner of the display apparatus can quickly provide a replacement display apparatus. For this reason, a loss of an opportunity to provide a service is suppressed.

### Appendix 10

The display apparatus management method described in any one of Appendices 7 to 9, wherein the second notification information includes information indicating that a measurement value concerning the luminance of the first display apparatus is smaller than the first threshold.

With the management method according to Appendix 10, since the second notification information includes the information indicating that the measurement value concerning the luminance of the first display apparatus is smaller than the first threshold, an owner of a display apparatus can quickly provide a replacement display apparatus when the luminance of the display apparatus decreases. Therefore, the satisfaction of the user is improved.

### Appendix 11

A display system including: a first information processing apparatus configured to store at least one of first identification information and second identification information and use form information, the first information processing apparatus being connected to a first display apparatus via a communication network, the first identification information being identification information indicating the first display apparatus, the second identification information being identification information indicating a user of the first display apparatus, the use form information being correlated with the at least one of the first identification information and the second identification information, the use form information being information for limiting at least a part of a use form of a function of the first display apparatus, the first information processing apparatus transmitting the use form information to the first display apparatus based on at least one of the first identification information and the second identification information; and the first display apparatus configured to project a projection image based on the use form information.

With the display system according to Appendix 11, since the display system includes the first display apparatus that projects the projection image based on the use form information that is information for limiting at least a part of the use form of the function of the first display apparatus, it is possible to match a service desired by the user under a contract and a service actually provided by a display apparatus.

### Appendix 12

An information processing apparatus, the information processing apparatus storing at least one of first identification information and second identification information, the information processing apparatus being connected to a first display apparatus and a second display apparatus via a communication network, the information processing apparatus storing a first threshold that is a threshold of luminance of the first display apparatus, the first identification information being identification information indicating the first display apparatus, the second identification information being identification information indicating a user of the first display apparatus, the first threshold being correlated with the at least one of the first identification information and the second identification information, wherein, when the information processing apparatus receives second notification information concerning a state of the first display apparatus and when luminance of the second display apparatus exceeds the first threshold, the second display apparatus is presented as a candidate replacement display apparatus for the first display apparatus.

With the management method according to Appendix 12, when the second notification information concerning the state of the first display apparatus is received by the information processing apparatus and when the luminance of the second display apparatus exceeds the first threshold, since the second display apparatus is presented as the candidate replacement display apparatus for the first display apparatus, an owner can reduce a load of work of extracting the candidate replacement display apparatus for the first display apparatus.

What is claimed is:

1. A display apparatus management method comprising:
storing, with a first information processing apparatus, at least one of first identification information and second identification information and use form information;
connecting, with the first information processing apparatus, to a first display apparatus via a communication network;
transmitting, with the first information processing apparatus, the use form information to the first display apparatus based on at least one of the first identification information and the second identification information; and
causing the first display apparatus to project a projection image based on the use form information, wherein the first identification information is identification information indicating the first display apparatus,
the second identification information is identification information indicating a user of the first display apparatus,
the use form information is correlated with the at least one of the first identification information and the second identification information, and
the use form information is information for limiting at least a part of a use form of a function of the first display apparatus.

2. The display apparatus management method according to claim 1, wherein
the storing includes: storing, with the first information processing apparatus, third identification information and the use form information in correlation with each other; and storing, with the first information processing apparatus, the first identification information and the third identification information in correlation with each other, and
the third identification information is identification information indicating a fixture for installing the first display apparatus in a use space.

3. The display apparatus management method according to claim 1, wherein
the use form information includes a first threshold that is a threshold of luminance of the first display apparatus, and
the method further includes outputting first notification information with the first display apparatus or the first information processing apparatus when a measurement value concerning the luminance of the first display apparatus is smaller than the first threshold.

4. The display apparatus management method according to claim 1, wherein
the use form information includes a second threshold that is a threshold of luminance of the first display apparatus, and
the method further includes, when a setting value concerning a light source of the first display apparatus exceeds the second threshold, changing the setting value to the second threshold or smaller with the first display apparatus.

5. The display apparatus management method according to claim 1, wherein
the use form information includes a second threshold that is a threshold of luminance of the first display apparatus, and
the method further includes, when a change request for changing a setting value concerning a light source of the first display apparatus to a value exceeding the second threshold is received by the first display apparatus or the first information processing apparatus, outputting, with the first display apparatus or the first information processing apparatus, information for rejecting the change request.

6. The display apparatus management method according to claim 1, wherein
the use form information includes a second threshold that is a threshold of luminance of the first display apparatus, and
the method further includes displaying, with the first display apparatus or the first information processing apparatus, a setting screen based on the second threshold.

7. A display apparatus management method comprising:
storing, with a first information processing apparatus, at least one of first identification information and second identification information;
connecting, with the first information processing apparatus, to a first display apparatus and a second display apparatus via a communication network;
storing, with the first information processing apparatus, a first threshold that is a threshold of luminance of the first display apparatus; and
presenting the second display apparatus as a candidate replacement display apparatus for the first display apparatus when the first information processing apparatus receives second notification information concerning a state of the first display apparatus and when luminance of the second display apparatus exceeds the first threshold, wherein
the first identification information is identification information indicating the first display apparatus,
the second identification information is identification information indicating a user of the first display apparatus, and
the first threshold is correlated with the at least one of the first identification information and the second identification information.

8. The display apparatus management method according to claim 7, further comprising:
storing, with the first information processing apparatus, a threshold of luminance of the second display apparatus; and
projecting, with the second display apparatus, a projection image based on the threshold of the luminance of the second display apparatus, wherein the threshold of the luminance of the second display apparatus is equal to a value of the first threshold.

9. The display apparatus management method according to claim 7, wherein the second notification information includes information concerning an abnormality of the first display apparatus.

10. The display apparatus management method according to claim 7, wherein the second notification information includes information indicating that a measurement value concerning the luminance of the first display apparatus is smaller than the first threshold.

11. A display system comprising:
a first information processing apparatus configured to store at least one of first identification information and second identification information and use form information,
the first information processing apparatus being connected to a first display apparatus via a communication network,
the first identification information being identification information indicating the first display apparatus,
the second identification information being identification information indicating a user of the first display apparatus,
the use form information being correlated with the at least one of the first identification information and the second identification information,
the use form information being information for limiting at least a part of a use form of a function of the first display apparatus,
the first information processing apparatus transmitting the use form information to the first display apparatus based on at least one of the first identification information and the second identification information; and
the first display apparatus configured to project a projection image based on the use form information.

12. An information processing apparatus,
the information processing apparatus storing at least one of first identification information and second identification information,
the information processing apparatus being connected to a first display apparatus and a second display apparatus via a communication network,
the information processing apparatus storing a first threshold that is a threshold of luminance of the first display apparatus,
the first identification information being identification information indicating the first display apparatus,
the second identification information being identification information indicating a user of the first display apparatus,
the first threshold being correlated with the at least one of the first identification information and the second identification information, wherein
when the information processing apparatus receives second notification information concerning a state of the first display apparatus and when luminance of the second display apparatus exceeds the first threshold, the second display apparatus is presented as a candidate replacement display apparatus for the first display apparatus.
